(19) United States
(12) Patent Application Publication
(10) Pub. No.: US 2025/0362448 A1
(43) Pub. Date: Nov. 27, 2025

(54) MANUFACTURING METHOD AND STRUCTURE OF A FIBER COMPONENT THAT PROVIDES LOW SIGNAL TRANSMISSION LOSS AND STRIPS CLADDING POWER

(71) Applicant: Photonicore Technologies Co., Ltd., Tainan City (TW)

(72) Inventors: HUNG-YING CHANG, Tainan City (TW); PAI-SHENG SHEN, Tainan City (TW)

(21) Appl. No.: 18/672,058

(22) Filed: May 23, 2024

(30) Foreign Application Priority Data
Jul. 10, 2023 (TW) 112125620

(51) Int. Cl. G02B 6/036

(52) U.S. Cl. CPC G02B 6/036

(57) ABSTRACT

The invention relates to a manufacturing method and structure of a fiber component that provides low signal transmission loss and strips cladding power. Special processing is performed on the optical fiber, and then the residual pump source of different modes of the fiber cladding is stripped. This fiber optic component is often called cladding power stripper (CPS). The CPS is designed for high power fiber laser to dissipate cladding light and keep the signal power transmitted in the core. CPS device can efficiently strip cladding residual pump power while preserving minimal degradation of signal power and beam quality (M2). Furthermore, reflected signal power back into the inner cladding can be stripped out by CPS, and protected the other components in the fiber laser system.

### BACKGROUND OF THE INVENTION

### 1. Field of the Invention

The invention relates to a manufacturing method and structure of a fiber component that provides low signal transmission loss and strips cladding power. Special processing is performed on the optical fiber, and then the residual pump source of different modes of the fiber cladding is stripped. Compared with the method on the market that uses hydrofluoric acid etching to reduce the thickness of the fiber cladding layer, the invention adopts cutting processing to avoid affecting the fiber core and maintain low signal transmission loss. Moreover, the optical fiber provided by the invention can retain the thickness and maintain the strength compared to etching, and strip the different modes of light transmitted in the optical fiber cladding layer, so that the laser system can operate stably.

### 2. Description of Related Art

The Cladding Power Stripper (CPS) is one of the important components of the high-power fiber laser system. It is used to strip the residual pump source in the fiber cladding from the resonant cavity and the laser reflected from the laser output. An ideal cladding power stripper features high stripping efficiency, low signal loss, low beam quality degradation, high-temperature stability, high power handling capability, and extreme reliability. It helps you ensure that optical powers can be absorbed efficiently and that generated heat can be dissipated safely without affecting or damaging the surrounding components. A cladding power stripper is widely used in fiber amplifiers, fiber laser systems, ASE stripping, and etc.

The unwanted light in the cladding of the fiber leads to poor beam quality and affects system efficiency. These effects can be more pronounced when you are working with high-power systems. Apart from improving the beam quality, you might also want to prevent the residual light from accompanying the amplified signal or from reaching the signal source. Undesired light in the cladding can also lead to excessive heat which can destroy the coating. Hence, you will need to use cladding power strippers to remove the unwanted light that transmitted in the cladding.

The pump source generated by the laser diode is coupled into the cladding of the fiber through a fiber combiner to provide power for the active fiber. It is absorbed and amplified in the core of the fiber to generate signal laser. However, the pump source will not be completely absorbed by the active fiber and the unabsorbed pump source becomes residual light. The residual light will transmit to the laser output end in the cladding of the fiber, affect the beam and quality of the signal light output, or even damage other components at the output end.

In addition, CPSs are used to strip the laser light reflected from the output end of a work piece in fiber laser applications. This laser light will affect the operation of the laser resonant cavity components and even damage the laser diode through the fiber combiner. Therefore, how to efficiently strip away the undesired light in the cladding of the fiber is the key to the optical fiber.

In the conventional art, there are two process of manufacturing a CPS as detailed below.

After peeling off the coating of the double cladding of a passive fiber, a single or multi-segment section is provided on the surface of the cladding of the passive fiber along the fiber axis, and hydrofluoric acid is used to etch the fiber. The purpose of the etching is to destroy the transmission path of light in the cladding and scatter it into the environment. Then ammonium fluoride is added to the hydrofluoric acid solution, ammonium fluoride is used to cause the surface of the optical fiber to become rough and uneven, and cause the residual light to scatter from the cladding. Most conventional CPSs are made by this method. Although the CPSs made by etching can effectively strip residual light, but the method may produce high fiber core transmission loss (i.e., insertion loss (IL) measured in decibels, (dB)). The IL of commercially available CPS products is mostly set at 0.2 dB. If a CPS is used in a 2 kW laser system, it will cause the system to lose about 100 W of signal light, which is a great amount of power. Regarding loss due to the etching process, there is no guarantee that only the cladding of the fiber will be etched. Since the material of the optical fiber is silicon dioxide, it has micro-cracks. Hydrofluoric acid may penetrate into the fiber core along the micro-cracks and destroy the fiber coating layer. The waveguide conditions cause transmission loss, resulting in extreme power loss of the fiber laser system.

In the literature, another way to make CPS is to coat the material with a specific refractive index on the cladding. After the stripping coating layer of the passive double cladding fiber, a single or multiple sections are provided on the cladding of the fiber along the axial direction of the fiber to coated or plate with a specific refractive index. The light will guide into the material of the specific refractive index to cause power attenuation. To achieve the desired stripping efficiency, several meters of material with a specific refractive index needs to be coated on the fiber causing the component to be too long. Another design concern with this method is whether the coating material can withstand the transmission of high-power energy over a long period of time. Another design concern with this method is whether the coating material can withstand the transmission of high-power energy over a long period of time.

### SUMMARY OF THE INVENTION

The invention relates to a manufacturing method and structure of a fiber component that provides low signal transmission loss and strips cladding power. Therefore, an object of the invention is to provide a novel process method, which includes physical polishing and grinding and chemical substance spraying to produce a cladding power stripper.

The invention has the following advantages and benefits in comparison with the conventional art:

A method of manufacturing optical fibers that improves signal transmission and strips cladding power. It contains an optical fiber, which includes double cladding. The coating layer of the optical fiber is stripped to form a bare fiber section with exposing the fiber cladding layer, which is characterized by:

The bare fiber section is processed to form an uneven surface that destroys the light transmission of the fiber cladding layer. The aforementioned uneven surface is gradually concave from both ends to the center and has a slightly trough-like appearance. The concave and convex surfaces are used to change the angle between the incident light of the fiber cladding layer and the boundary between the cladding and the outside part, so that the total reflection condition cannot be achieved and used to destroy the optical fiber light guide, thereby stripping away the different modes of light transmitted in the optical fiber.

The above and other objects, features and advantages of the invention will become apparent from the following detailed description taken with the accompanying drawings.

### BRIEF DESCRIPTION OF THE DRAWINGS

FIG. 1 is a perspective view of an optical fiber according to the invention;

FIG. 2 is a perspective view of the optical fiber having two uneven surfaces;

FIG. 3 is a side elevation of FIG. 2;

FIG. 4 is a view similar to FIG. 3 showing the uneven surface being processed to shape as teeth;

FIG. 5 is a flowchart of a process of manufacturing the optical fiber according to the invention; and

FIG. 6 is a table tabulating laser output DAC, input power, output power, and CPS shell temperature at different conditions in an experiment according to the invention.

### DETAILED DESCRIPTION OF THE INVENTION

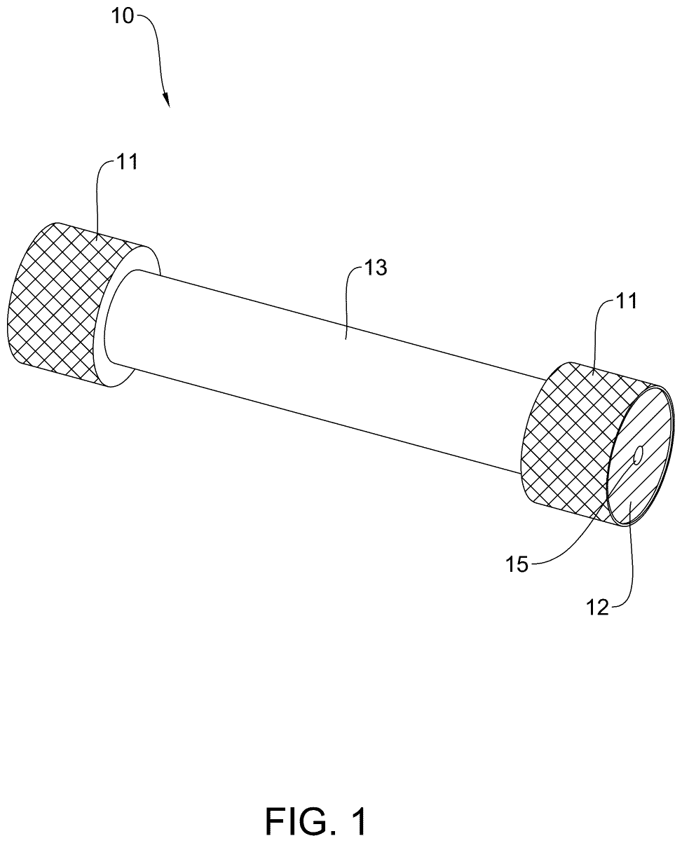

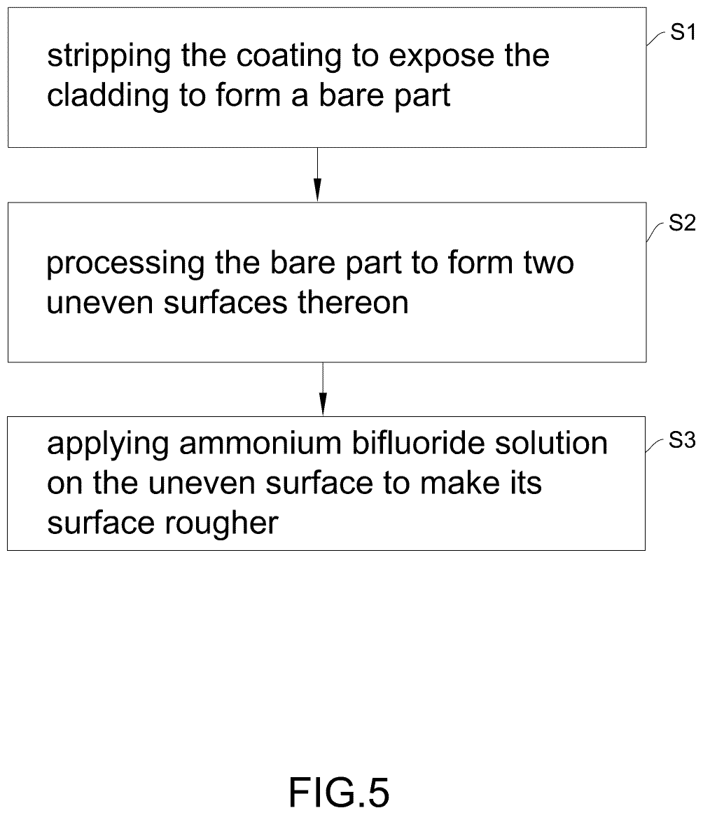

Referring to FIGS. 1 to 6 in which FIGS. 1-4 show an optical fiber (e.g., double cladding of a passive fiber) 10 of the invention and FIG. 5 is a flowchart illustrating a process of manufacturing the optical fiber of the invention.

The optical fiber 10 is shaped as a barbell and comprises two coatings 11 at two ends respectively. The coating 11 is stripped to expose an internal fiber coating layer 12 which is in turn further stripped to form a bare part 13 interconnected the coatings 11 (see step S1 of FIG. 5).

The bare part 13 is processed to form two uneven surfaces 14 thereon (see step S2 of FIG. 5). The uneven surface 14 is concave toward a center and wavy. The uneven surface 14 can change an angle of incident light. This further destroys waveguide conditions of the optical fiber 10 and causes the light to be unable to form total internal reflection in the fiber cladding 12. Then, the different modes of light transmitted in the fiber cladding 12 are stripped.

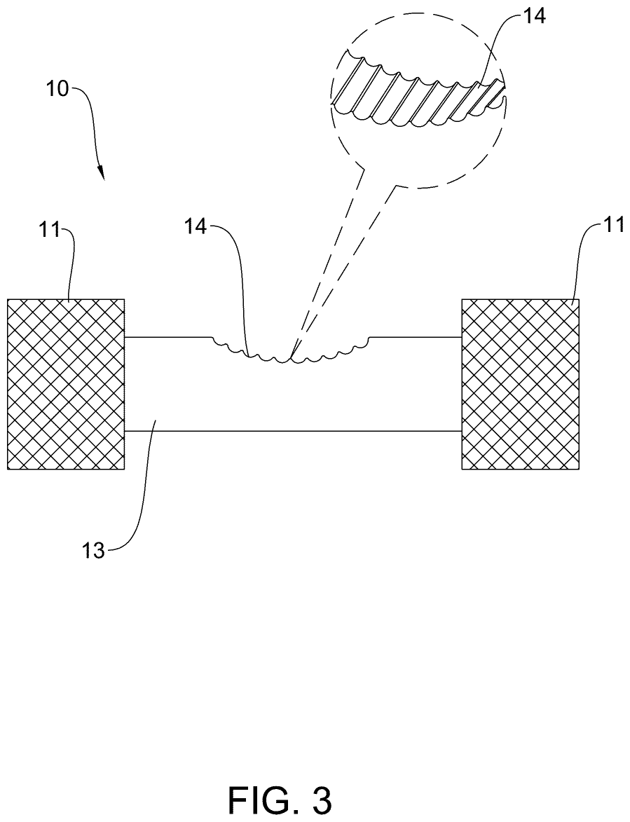

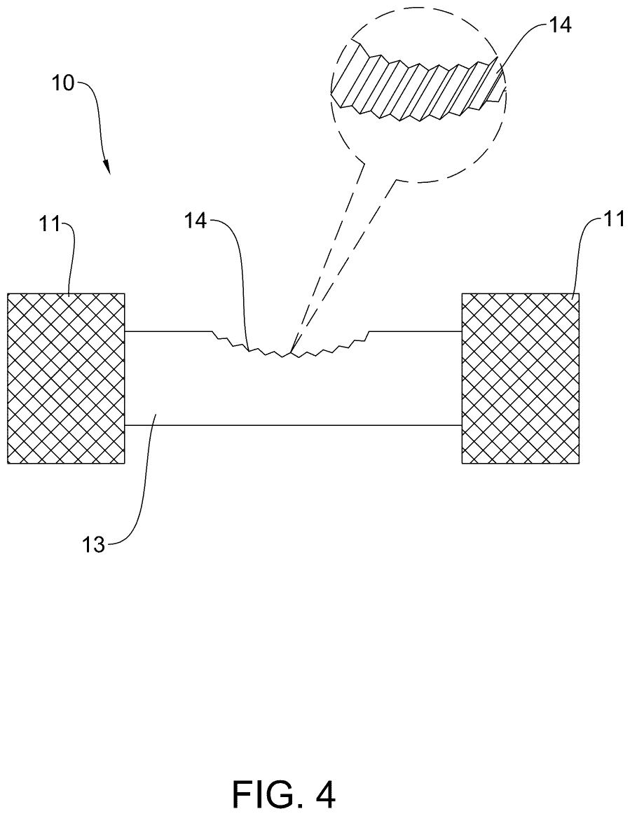

Specifically, the bare part 13 is etched by laser to form the uneven surfaces 14 thereon. The uneven surfaces 14 are wavy (see FIG. 3). Further, the uneven surfaces 14 can be etched by laser to shape as teeth (see FIG. 4).

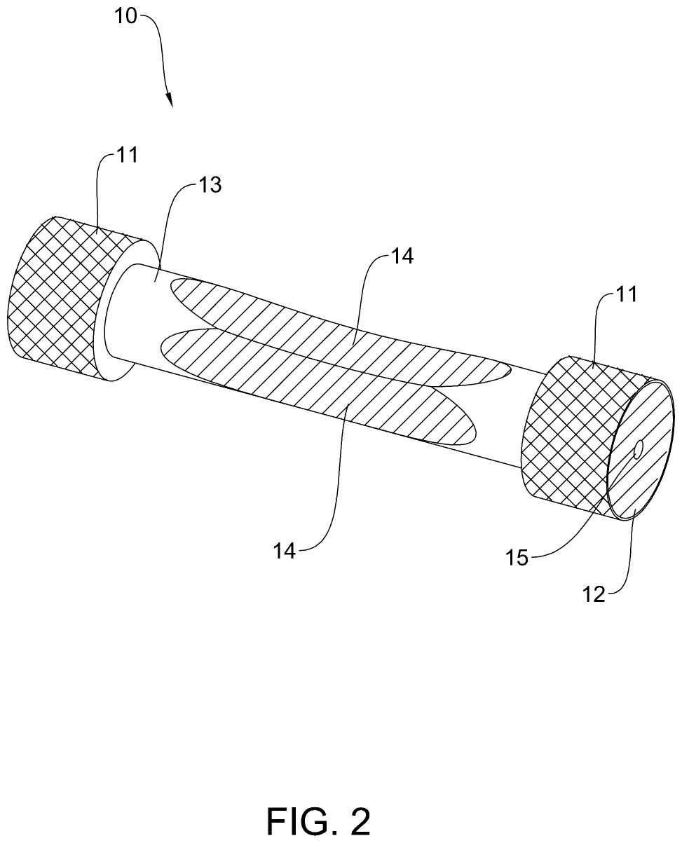

Alternatively, the bare part 13 is polished by s sand paper or a polishing wheel to form the uneven surfaces 14. As shown in FIG. 2 specifically, the uneven surface 14 is concave toward a center. The uneven surfaces 14 are wavy (see FIG. 3). Further, the uneven surfaces 14 can be cut or grinded to shape as teeth (see FIG. 4). The total internal reflection condition of the cladding 12 is damaged. As a result, a plurality of different modes of transmitting light in the fiber cladding layer 12 are not delivered.

As shown in FIG. 2 specifically, one uneven surface 14 formed on the bare part 13 is at an angle of 90-degree with respect to the other uneven surface 14 formed on the bare part 13. Basically, one uneven surface 14 is sufficient to change an angle of incident light from a pump light source to destroy the total internal reflection of the fiber cladding 12. In FIG. 2, it is revealed that the angle between the two uneven surfaces is 90 degrees, so that the light in different quadrants of the fiber cladding does not have the requirement for total internal reflection. In detail, when the residual pump light from the laser resonant cavity or the laser light reflected from the laser output end in the fiber cladding passes through the CPS. Uneven surfaces can achieve progressive stripping from shallow to deep, preventing components from rapidly heating and burning due to excessive stripping power per unit area. Therefore, the optical fiber component manufactured by the invention has the advantages of high stripping efficiency, high power tolerance, uniform temperature distribution, long service life, and high stability.

It is worth mentioning that the angle between the two uneven surfaces 14 is 90 degrees as shown in FIG. 2, but the actual application is not limited to this. Other angles are possible in other embodiments. The uneven surfaces 14 have the following characteristics:
1. The optical fiber is processed to form at least two sets of uneven surfaces 14 at the same axial position but in different directions. Two uneven surfaces 14 intersect, and the normal lines of the two uneven surfaces intersect at no specific angle.
2. The optical fiber is processed to form at least two sets of uneven surfaces 14 in the same direction at different axial positions. The distance between the two uneven surfaces is not limited.
3. The optical fiber is processed to form at least two sets of uneven surfaces 14 at different axial positions and different directions. The distance between the two uneven surfaces is not limited, and the normal angle between the two uneven surfaces is not limited.

In step S3 of FIG. 5, the ammonium bifluoride solution can be sprayed on the uneven surfaces to etch the surface to form a rough surface, thereby improving the stripping efficiency. Due to the spraying method, the amount of liquid used is very small. A small amount of ammonium bifluoride solution will only etch the surface of the fiber cladding and the uneven surfaces, and will not cause transmission loss of the fiber core.

The invention can greatly decrease light transmission loss in comparison with the conventional products. According to the experimental results, an optical signal of 11.958 mw was input to the fiber component, and the power measured at the output end of 11.903 mw. The insertion loss (dB) was calculated to be 0.05 dB. In detail, insertion loss of the optical fiber of the invention is 0.0.5 dB (i.e., about 1.2%) and insertion loss of the conventional optical fiber products is 0.2 dB (i.e., about 4.3%).

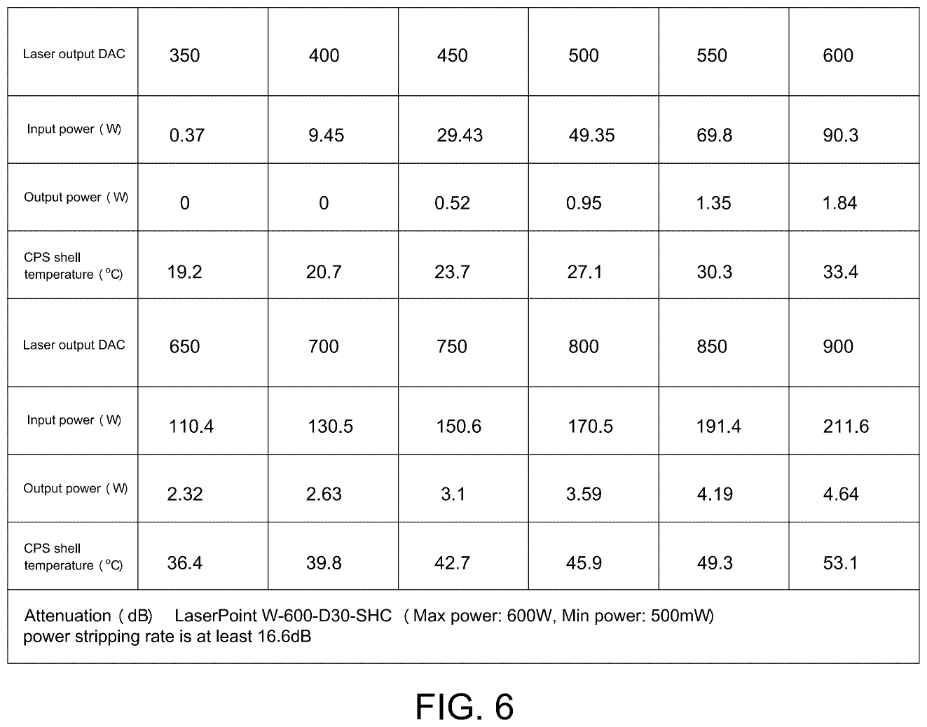

In another experiment, using a 2 k-watt optical fiber laser as the signal source, the insertion loss of the signal light in the optical fiber component produced by the invention is about 24 W. The insertion loss of commercially available products is about 86 W. Therefore, the invention can reduce fiber core transmission loss by 62 W compared with commercially available products. Results of the experiment are shown in FIG. 6.

As shown in FIG. 5 specifically, in step S3, a small amount of ammonium bifluoride solution is applied on the uneven surfaces 14 to etch same. As such, cracks are formed on the uneven surfaces 14, i.e., being further uneven so as to further increase power stripping performance. The light transmission function of the fiber core 15 of the fiber coating layer 12 is not neutralized because the ammonium bifluoride solution only corrodes the surface of the fiber coating layer 12 and the uneven surfaces 14.

The invention can greatly decrease light transmission loss in comparison with the conventional optical fiber products. For example, it is found that energy measured at an output end is 11.903 mw and energy, measured at an input end is 11.958 mw in an experiment, i.e., insertion loss being 0.05 dB. In detail, insertion loss of the optical fiber of the invention is 0.0.5 dB (i.e., about 1.2%) and insertion loss of the conventional optical fiber products is 0.2 dB (i.e., about 4.3%).

In another experiment, 2000 W signal laser is generated by 2000 W laser emitted by an optical fiber. For the optical fiber of the invention, the 2000 W signal laser has an insertion loss of about 24 W. For the conventional optical fiber, the 2000 W signal laser has an insertion loss of about 86 W. That is, the invention can decrease 62 W insertion loss. Results of the experiment are shown in FIG. 6.

It is concluded that the laser light emitted by the optical fiber of the invention has the advantages of being quality, stable power, uniform temperature and prolonged useful life.

While the invention has been described in terms of preferred embodiments, those skilled in the art will recognize that the invention can be practiced with modifications within the spirit and scope of the appended claims.

What is claimed is:

1. An optical fiber component, comprising:
a double cladding fiber including two coatings at two ends respectively, a fiber core layer, and a fiber cladding;
a bare part interconnected the coating, and;
a plurality of uneven surfaces formed on the bar part;
wherein each of the uneven surfaces are concave toward a center; and
wherein the optical fiber component is a double cladding of a passive fiber.

2. The optical fiber component of claim 1, wherein the bare fiber part is processed to form an uneven surface that destroys the light guide of the fiber cladding, due to the uneven surfaces are configured to change an angle of incident light impinged on the fiber cladding so that the total internal reflection of boundary between the cladding and outside is changed, and a plurality of different modes of transmitting light in the fiber cladding are not delivered.

3. The optical fiber component of claim 2, wherein the bare part is cut by laser to form the concave and convex surface, and the uneven surfaces are wavy.

4. The optical fiber component of claim 2, wherein the bare part is cut or grinded to form the uneven surfaces thereon, and the uneven surfaces are wavy or toothed-shaped.

5. The optical fiber component of claim 2, where in the bare part is polished by a sand paper or a polishing wheel to form the uneven surfaces thereon.

6. The optical fiber component of claim 2, wherein the optical fiber is processed to form at least two sets of uneven surfaces at the same axial position but in different directions, any two uneven surfaces intersect, and the normal lines of the two uneven surfaces intersect at no specific angle.

7. The optical fiber component of claim 2, wherein the optical fiber is processed to form at least two sets of uneven surfaces in the same direction at different axial positions, and the distance between the any two uneven surfaces is not limited.

8. The optical fiber component of claim 2, wherein the optical fiber is processed to form at least two sets of uneven surfaces at different axial positions and different directions, the distance between any two uneven surfaces is not restricted, and the normal angle between these two uneven surfaces is not restricted.

9. The optical fiber component of claim 2, wherein an amount of ammonium bifluoride solution is applied on the uneven surfaces to etch to form rough surfaces so that the uneven surfaces are configured to further increase power stripping on the fiber cladding and guide light to the environment.

10. The optical fiber component of claim 3, wherein an amount of ammonium bifluoride solution is applied on the uneven surfaces to etch to form rough surfaces so that the uneven surfaces are configured to further increase power stripping on the fiber cladding and guide light to the environment.

11. The optical fiber component of claim 4, wherein an amount of ammonium bifluoride solution is applied on the uneven surfaces to etch to form rough surfaces so that the uneven surfaces are configured to further increase power stripping on the fiber cladding and guide light to the environment.

12. The optical fiber component of claim 5, wherein an amount of ammonium bifluoride solution is applied on the uneven surfaces to etch to form rough surfaces so that the uneven surfaces are configured to further increase power stripping on the fiber cladding and guide light to the environment.

13. The optical fiber component of claim 6, wherein an amount of ammonium bifluoride solution is applied on the uneven surfaces to etch to form rough surfaces so that the uneven surfaces are configured to further increase power stripping on the fiber cladding and guide light to the environment.

14. The optical fiber component of claim 7, wherein an amount of ammonium bifluoride solution is applied on the uneven surfaces to etch to form rough surfaces so that the uneven surfaces are configured to further increase power stripping on the fiber cladding and guide light to the environment.

15. The optical fiber component of claim 8, wherein an amount of ammonium bifluoride solution is applied on the uneven surfaces to etch to form rough surfaces so that the uneven surfaces are configured to further increase power stripping on the fiber cladding and guide light to the environment.
